(19) United States
(12) Patent Application Publication
(10) Pub. No.: US 2026/0297978 A1
(43) Pub. Date: Oct. 1, 2026

(54) MODULAR ASSEMBLY FOR ARCHITECTURAL HARDWARE

(71) Applicant: ASSA ABLOY Accessories and Door Controls Group, Inc., New Haven, CT (US)

(72) Inventors: Matthew Donaldson, Meyersdale, PA (US); Heather Faircloth, Somerset, PA (US); Kyle R. Murray, Somerset, PA (US); Sam Wiedner, Friedens, PA (US)

(73) Assignee: ASSA ABLOY Accessories and Door Controls Group, Inc., New Haven, CT (US)

(21) Appl. No.: 19/635,172

(22) Filed: Mar. 31, 2026

Related U.S. Application Data
(60) Provisional application No. 63/781,587, filed on Apr. 1, 2025.

(51) Int. Cl. E05B 1/00; F16B 7/04

(52) U.S. Cl. CPC E05B 1/0015; F16B 7/042

(57) ABSTRACT

A modular architectural hardware device includes a first and second connector. The first and second connectors may couple with modular components of the modular architectural hardware device. The connectors may then couple together to bring the modular components together to form the single architectural hardware device.

### CROSS-REFERENCE TO RELATED APPLICATIONS

This application claims the benefit of priority under 35 U.S.C. § 119(e) to U.S. Provisional Application Ser. No. 63/781587 filed on Apr. 1, 2025, which is hereby incorporated by reference in its entirety.

### FIELD

Disclosed embodiments are related to modular architectural hardware.

### BACKGROUND

Architectural hardware such as push bars for exit devices, door frames, or handles may be bulky, making it challenging to ship or otherwise move the architectural hardware. In some arrangements, such architectural hardware may be modular so that they may be assembled by a user prior to installation.

### SUMMARY

In some embodiments, a modular architectural hardware device is provided. The modular architectural hardware device may include a first section and a second section. The first section may be configured to contact the second section when the first section is coupled to the second section and moved to a locking configuration. The first section and the second section may have complementary non-circular profiles whereby the second section may be configured to be inserted into the first section in only one rotational orientation.

In some embodiments, a modular architectural hardware device is provided. The modular architectural hardware device may include a first section having an interior portion and a second section having an interior portion. The modular architectural hardware device may include a first connector configured to couple to the interior portion of the first section and a second connector configured to couple to the interior portion of the second section. The second connector may be further configured to couple to the first connector. The first connector may be configured to move to a first secure position when coupled to the interior portion of the first section by a press fit. The second connector may be configured to move to a second secure position when coupled to the interior portion of the second section by a press fit. The first section may be configured to contact the second section when the first connector in the first secure position is coupled to the second connector in a second secure position and moved to a locking configuration.

In some embodiments, a modular architectural hardware device is provided. The modular architectural hardware device may include a first section having an interior portion and a second section having an interior portion. The modular architectural hardware device may include a first connector configured to couple to the interior portion of the first section and a second connector configured to couple to the interior portion of the second section. The second connector may be further configured to couple to the first connector. The first connector may be configured to move to a first secure position when coupled to the interior portion of the first section. The second connector may be configured to move to a second secure position when coupled to the interior portion of the second section. The first section may be configured to contact the second section when the first connector in the first secure position is coupled to the second connector in a second secure position, and when the first connector moves to a locking configuration. The first connector may include a detent. The second connector may include a ramp configured to receive the detent. The ramp may have a receiving end. The ramp may be sloped to receive the detent at the receiving end and depress the detent as the first connector moves towards a locking end to the locking configuration while coupled to the second connector. The depressed detent may be released when the first connector is in the locking configuration.

### BRIEF DESCRIPTION OF DRAWINGS

FIG. 1 shows on embodiment of a piece of modular architectural hardware device in an assembled state on a door;

FIG. 2 shows an exploded view of the modular architecture hardware device of FIG. 1;

FIG. 3 shows an enlarged view of the exploded view of the modular architectural hardware device of FIG. 2;

FIG. 4 shows an enlarged view of the modular architectural hardware device of FIG. 1 in a partially assembled state;

FIGS. 5A-E show a side view of the modular architectural hardware of FIG. 1 being assembled in various stages.

FIG. 6 shows an end view of one embodiment of a first connector of the modular architectural hardware device of FIG. 1; and

FIG. 7 shows an end view of one embodiment of a second connector of the modular architectural hardware device of FIG. 1.

### DETAILED DESCRIPTION

Many architectural hardware devices such as push bars for exit devices, door frame, or handles are irregularly shaped, heavy, or otherwise burdensome to transport. It may be desirable for architectural hardware device to be modular. It should be appreciated that modular hardware device may include a series of smaller components that may be more easily transported, organized, or repaired. In addition, many architectural hardware devices may have hollow tubular components that help reduce part weight. The Inventors have appreciated that modular hardware devices may introduce additional potential failure points, interfere with the aesthetic, or be challenging to assemble in the field. In some embodiments, a modular architectural hardware device may include two sections, and a connection configured to connect the two sections of the modular architectural hardware device. The two sections may be at least partially tubular. In some embodiments, a connection may be configured to fit inside tubular sections of a modular architectural hardware device so that the connector may bring the two sections together to form a single architectural hardware component. It should be appreciated that the connection may be two separate connectors, wherein a first connector is configured to couple to the first section, and a second connector is configured to couple to the second section. The two connectors may then couple to each other to connect the two sections. It should be appreciated that once the two sections are connected, the connectors may no longer visible, or the connectors may only be partially visible. In one embodiment, the two tubular sections are coupled to appear as a single tubular piece.

In some embodiments, the connectors may couple to the respective tubular sections with a pressed fit. It should be appreciated that a pressed fit may also be referred to as a friction fit, or interference fit. The exterior profile of each connector may be complimentary to the interior profile of each respective tubular section. It should be appreciated the exterior connector profiles may be slightly smaller than the interior tubular section profiles to allow for the connectors to fit inside of the tubular sections. Alternatively, the connectors may be partially deformable to allow the connectors to deform to fit inside of the tubular sections. Once inside the tubular sections, the friction between the connectors and the tubular sections may securely hold the connectors in a secure position. In some embodiments, the first and second tubular section It should be appreciated that other coupling means are considered. For example, in other embodiments, the connectors may be held in place in the tubular sections by fasteners or adhesives or welds. In further embodiments, the exterior surfaces of the connectors and the interior surface of the tubular sections may be threaded so that the connectors screw into the tubular sections. It should be appreciated that the two connectors may couple the respective sections with different connecting arrangements. In some embodiments, the connectors may be integrated into the respective sections.

In some embodiments, it may be desirable for at least one of the sections to have an aperture, or similar hole. The corresponding connector to the at least one section may have at least one fastener such as a set screw incorporated into the connector. The fastener may be positioned to align with the aperture so that the fastener may be accessed and may fasten the connector to either the section or other connector. It should be appreciated that both sections may have an aperture, and both connectors may have a fastener. Alternatively, it should be appreciated that a connector may be configured to receive a fastener that fastens a connector to a section.

The Inventors have appreciated that it may be desirable to limit the orientations in which the two connectors are able to connect to each other. The Inventors have appreciated that this may simplify assembly by ensuring that a user can only assemble the modular hardware device in a single orientation. In some embodiments, one connector being a male connector may be inserted into the other connector being a female connector to couple the two connectors and connect the two sections. It should be appreciated that the first connector may be either a male or female connector, and the second connector may have the opposite configuration.

The Inventors have appreciated that it may be desirable for the profile of the male connector and the profile of the female connector to have complementary shapes so that the male connector may fit into the female connector. The shape of the profiles of the connectors may be partially rounded. For example, the profiles of the connectors may be “D” shaped, or substantially rectangular with rounded corners. In some embodiments, it may be desirable for the profiles of the connectors to have complementary non-circular profiles whereby the second connector is configured to be inserted into the first connector in only one rotational orientation. In some embodiments, the connectors may have complementary non-circular profiles that are rotationally asymmetrical about an axis perpendicular to the profile. It should be appreciated that allowing the connectors to couple in one orientation may ensure the assembly can only be assembled in one orientation. In some embodiments, a single assembly orientation may be desirable improve ease of assembly. In some embodiments, it may be desirable for the profiles of the connectors to be symmetrical about an axis parallel to each profile, so that the connectors may connect in a plurality of discrete orientations.

The Inventors have further appreciated that it may be desirable for connectors to securely couple so that they may not be easily separated, to provide a strong connection for the two sections. In some embodiments, a detent may be used to couple the two connectors. The detent may be a part of or coupled to a first connector and the detent may have a depressed state and a non-depressed state. It should be appreciated that the detent may be biased towards the non-depressed state by a spring, magnet, or similar biasing mechanism. In some embodiments, the detent may be depressed, and one connector may be inserted into the other connector. While the first and second connectors are coupled, the detent may be held in the depressed state by the second connector. It should be appreciated that the first connector, having the detent, may be either the male or female connector. It should be appreciated that while the detent is in the depressed state, the connectors may be able to translate relative to each other while coupled together. The first and second connectors may move to a locked state while coupled together. The Inventors have appreciated that while in the locked state, the second connector may not restrict the detent, and the detent may be released from the depressed state to the non-depressed state. While in the locked state, the non-depressed detent may restrict the movement of the first connector relative to the second connector. It should be appreciated that the first and second sections may be coupled to the first and second connectors when the connectors are in the locked state, so that the first and second sections are connected to form a single piece of the modular architectural hardware device.

The Inventors have appreciated that it may be desirable for the second connector to have a ramp. The ramp extends in a linear direction so that the connectors may only move along one axis relative to each other. The ramp may be configured to receive the detent of the first connector and gradually depress the detent as the connectors linearly translate relative to each other. The ramp may be oriented so that the first and second connector may couple together while the detent is in the non-depressed state, in a single orientation.

In some embodiments, the ramp may further have a constant incline so that the ramp depresses the detent at a constant rate as the connectors move linearly relative to each other and the detent moves along the length of the ramp. The slope of the ramp may preferably be similar to a slope of the detent at the point where the ramp contacts the detent to more easily allow the detent to move along the ramp. Other ramp inclines may also be contemplated. For example, the ramp may have a curved incline so that the slope of the ramp either increases or decreases as the detent moves along the length of the ramp.

The Inventors have appreciated that the ramp may form a notch in the profile of the second connector. It should be appreciated that the profile of the second connector with the notch may still be complimentary to the profile of the first connector. In some embodiments, the notch may be shaped to receive the detent of the first connector in a single configuration. In additional embodiments, it may be desirable to for the second connector to have a plurality of notches and ramps to allow for the detent to contact one of the ramps, allowing the connectors to connect in a plurality of orientations.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

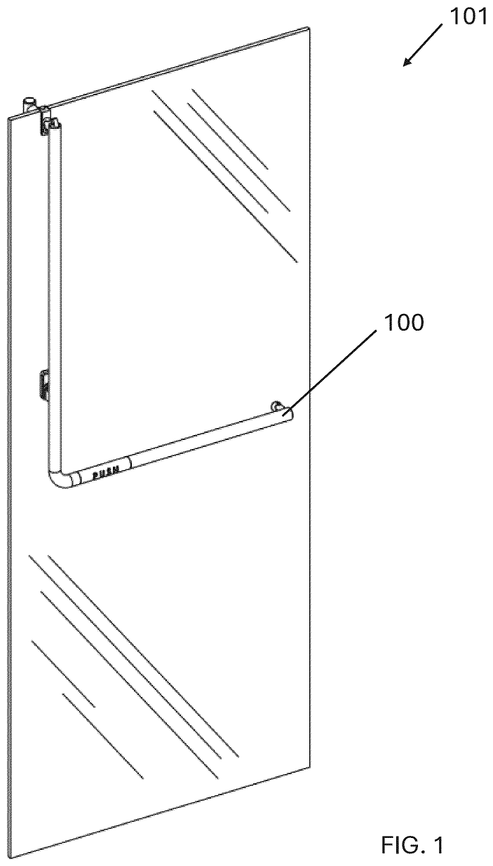

FIG. 1 illustrates a push bar 100 attached to a door 101, as a modular architectural hardware device. The push bar 100 is in a fully assembled state. The push bar 100 may be substantially “L” shaped. Alternatively in some embodiments, the push bar may be curved, “V” shaped, or straight for example. It should be appreciated that the shape of the push bar or other architectural hardware device is not limiting as it may be desirable for any shaped architectural hardware device to be modular. The push bar 100 may be at least partially tubular so that modular components of the push bar 100 may be connected at points of connection by connectors situated inside tubular portions of the push bar 100. It should be appreciated that connectors situated inside the tubular portions may not be fully visible when the push bar 100 is in an assembled state so that the push bar appears as a substantially single piece. In some embodiments, connectors may be partially visible, or the push bar may appear as multiple pieces. The push bar 100 may have multiple modular sections or multiple connectors and points of connection.

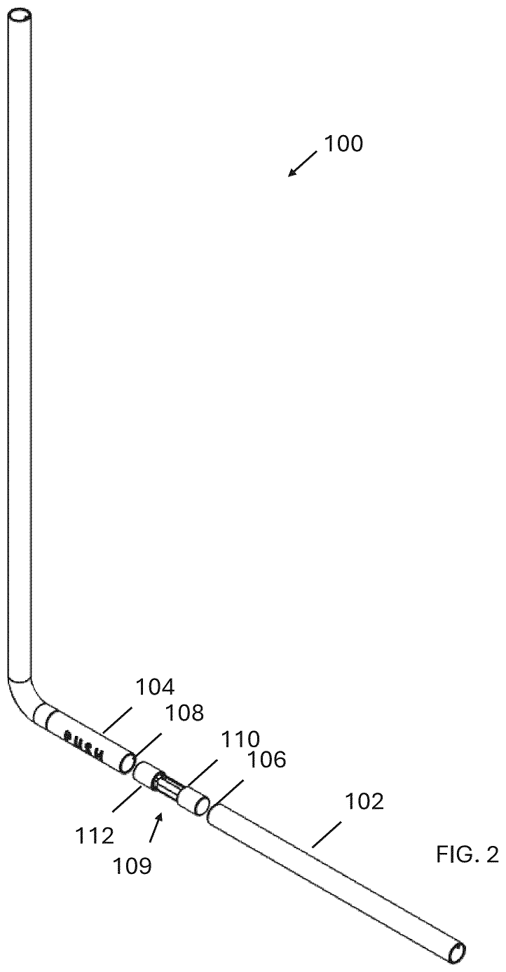

FIG. 2 illustrates the push bar 100 in a disassembled state. The push bar has at least a first tubular section 102 and a second tubular section 104, however push bars with additional tubular sections are also contemplated. The first tubular section 102 may have a first interior portion 106 and the second tubular section 104 may have a second interior portion 108. The interior portions 106 and 108 may receive a connection 109 that connects the tubular sections 102 and 104 to form the push bar 100. The connection 109 may have a first connector 110 configured to couple to the first tubular section 102 in the first interior portion 106. It should be appreciated that the first connector 110 may be complimentary in shape to the first interior portion 106. The connection 109 may have a second connector 112 configured to couple to the second tubular section 104 in the second interior portion 108. The second connector 112 may be complimentary in shape to the second interior portion 108. The first connector 110 and the second connector 112 may be connected together to bring the first tubular section 102 in contact with the second tubular section 104.

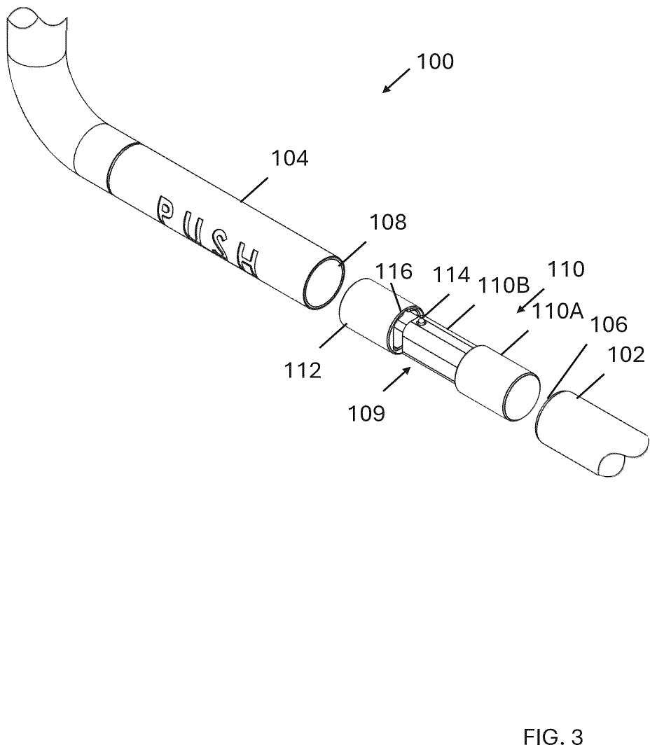

FIG. 3 illustrates the exploded view of the push bar 100 of FIG. 2 in greater detail. The first connector 110 may further have a detent 114. The detent 114 may be depressed or released. The detent 114 may be configured to be received by a ramp 116 of the second connector. It should be appreciated that the ramp 116 may receive the detent 114 as the first connector 110 couples to the second connector 112. The ramp 116 may depress the detent 114 as the detent 114 moves along the ramp 116.

The ramp 116 may only receive the detent in one orientation, causing the first connector 110 and the second connector 112 to only couple in one orientation. It should be appreciated that in alternate embodiments it may be desirable for there to be multiple ramps to receive the detent to allow the first and second connector to connect in a plurality of orientations. The first connector 110 may have a coupling end 110A configured to insert into the first interior portion 106 of the first tubular section 102 and a connecting end 110B configured to connect to an interior portion of second connector 112. Alternatively, in other embodiments, it may be desirable for the second connector to have a coupling end configured to insert into the second interior portion of the second tubular section and a connecting end configured to connect to an interior portion of the first connector. It may be desirable for the first connector 110 to couple to the second connector 112, while the first connector 110 is additionally coupled to the first tubular section 102 and the second connector 112 is additionally coupled to the second tubular section 104.

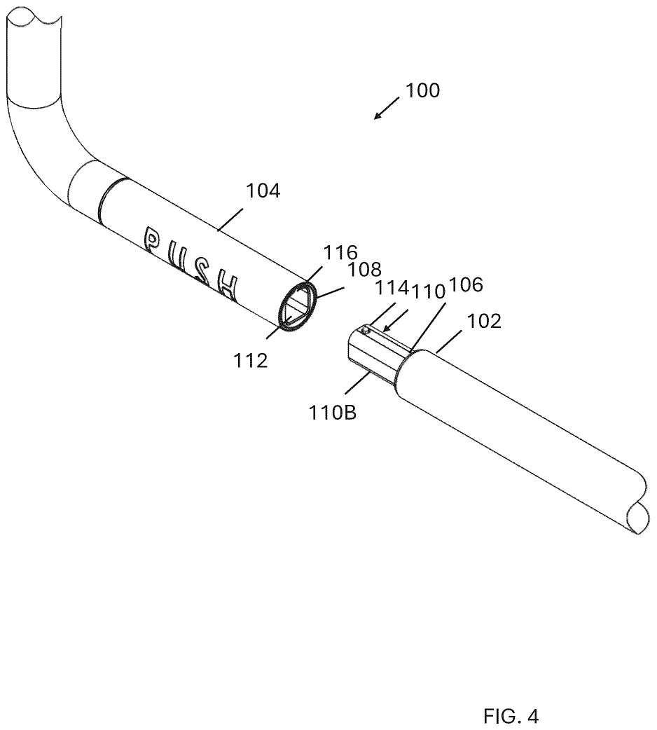

FIG. 4 illustrates the push bar 100 in a partially assembled state wherein the first connector 110 is coupled to the first tubular section 102 and the second connector 112 is coupled to the second tubular section 104. The first connector 110 may be partially inserted into the first tubular section 102 so that only the connecting end 110B is exposed. It should be appreciated that the first connector 110 is secured in the first tubular section 102 by a pressed fit (alternatively referred to as a friction fit, or interference fit), wherein the coupling end 110A of the first connector has a complimentary profile to that of the first interior portion 106 of the first tubular section 102. It should be appreciated that complimentary profiles of the coupling end 110A and the first interior portion 106 of the first tubular section 102 allows the first tubular section 102 to secure the first connector 110 with friction in a secure position. It should be appreciated that in alternative embodiments, other securing means may be considered. For example, the first tubular section and the connector may be threaded to allow for a threaded connection. In addition, fasteners or adhesives may be used to secure the first connector 110 to the first tubular section 102.

The second connector 112 may be similarly inserted into the second interior portion 108 of the second tubular section 104. The second connector 112 may be inserted into the second tubular section 104 in such a way that the second connector 112 is fully or partially inside the second tubular section 104. It should be appreciated that the second connector 112 is similarly secured into place in the second tubular section 104 by a pressed fit in a secure position. The second connector 112 may be further secured to the second tubular section 104 by a fastener, as will be further discussed. Other securing means such as a threaded portion, or adhesives are also considered. The first connector 110 and the second connector 112 do not need to be secured with the same securing means. In alternative embodiments, a second connector may have a connecting and a coupling end, such that the second connector is coupled to a second tubular section at the coupling end and the connecting end is exposed, while the first connector is fully or partially in the first tubular section (while lacking a coupling or connecting end).

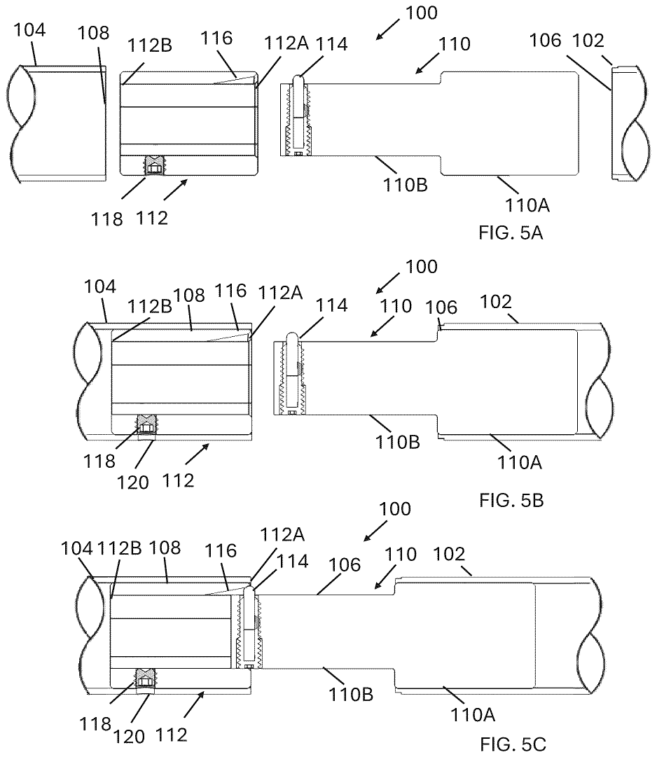

FIGS. 5A-5C illustrate a side section view of the push bar 100 at various stages of assembly. FIG. 5A illustrates the push bar 100 in a fully disassembled state, similarly to FIG. 3. The first connector 110 and the second connector 112 are uncoupled from each other and the tubular sections 102 and 104. The section view further illustrates the depressible detent 114 of the first connector 110 and the ramp 116 of the second connector 112. A set screw 118 is also illustrated in the second connector 112, the set screw 118 will be further discussed.

FIG. 5B illustrates the push bar 100 in a partially assembled state, similarly to FIG. 4. The first connector 110 may be inserted into the first interior portion 106 of the first tubular section 102. The size and shape of the first interior portion 106 of the first tubular section 102 is complementary in size and shape to the coupling end 110A of the first connector 110 so that the first connector 110 may be held into place in the first tubular section 102 by a pressed fit. Other connections are considered as previously discussed. While inserted, the coupling end 110A is substantially flush with the end of the first tubular section 102. In some embodiments, the coupling end 110A may not be flush with the end of the first tubular section 102. Similarly, the second connector 112 may be inserted into the second interior portion 108 of the second tubular section 104. The size and shape of the second interior portion 108 of the second tubular section 104 is complementary in size and shape of the second connector 112 so that the second connector 112 may be held into place in the second tubular section 104 by a pressed fit. Other connections are considered as previously discussed. While inserted, a receiving end 112A of the second connector 112 is substantially flush with the end of the second tubular section 104. In some embodiments, the receiving end 112A may not be flush with the end of the second tubular section 104. The second connector 112 may further be positioned so that the set screw 118 aligns with an aperture 120 in the second tubular section, to allow a user to access the set screw 118 while the push bar 100 is fully assembled. Other means for aligning the first or second connectors with respective the tubular sections such as markings, notches, apertures, guides, or stops are also considered.

FIG. 5C illustrates the push bar 100 partially assembled at a further step. The first tubular section 102 and first connector 110 are moved towards the second tubular section 104 and the second connector 112. The detent 114 may then couple with the ramp 116 at the receiving end 112A of the second connector 112. The height of the ramp 116 at the receiving end 112A may be sized to receive the detent 114 in a non-depressed state and contact the detent 114. The ramp 116 may gradually decline to depress the detent 114 to a depressed state. The detent 114 may have a curved surface at a point of contact with the ramp 116. The curved surface may assist the detent 114 to move along the ramp. Alternatively, the detent 114 may have a sloped surface having an approximately similar slope to the ramp 116 to assist the detent 114 to move along the ramp 116. Other detent contact configurations are also considered, for example the detent may have a roller that contacts the ramp, or a flat surface to contact the ramp. The detent 114 may be biased towards the non-depressed state by a spring, magnet, or other biasing mechanism.

Once the detent 114 of the first connector 110 is received by the second connector 112, the first connector 110 may be translated from the receiving end 112A of the second connector towards a locking end 112B of the second connector 112. The first connector 110 may have a male configuration and be inserted into an interior portion of the second connector 112 having a female configuration to couple the first connector 110 with the second connector 112. In some embodiments, the first connector may alternatively have a female configuration and receive the second connector having a male configuration. As the first connector 110 is positioned towards a locking end 112B of the second connector 112, the detent 114 is depressed to a depressed state as shown in FIG. 5D. The connecting end 110B of the first connector 110 may have a complimentary profile to the receiving end 112A of the second connector 112 to allow the connectors 110 and 112 to couple in a limited number of configurations as will be further discussed. The first connector 110 and the second connector 112 may both move relative to each other, or only one connector may move. The first connector 110 and the second connector 112 may both remain in a secure position in the first tubular section 102 and the second tubular section 104 respectively, as the connectors 110, 112 couple.

FIG. 5E illustrates the push bar 100 in a fully assembled state, similar to FIG. 1. The first tubular section 102 and the second tubular section 104 are brought together to form an apparently single piece push bar 100. The first connector 110 and second connector 112 are in a locking configuration, where the first connector 110 and second connector 112 can no longer move relative to each other. While in the locking configuration, the detent 114 is no longer depressed by the second connector 112 and restricts the connectors 110 and 112, so that the first connector 110 cannot translate linearly in a direction from the locking end 112B towards the receiving end 112A of the second connector. The first tubular section 102 and the second tubular section 104 contact one another when the connectors 110 and 112 are in the locking configuration, so that the first connector 110 cannot further translate linearly in a direction from the receiving end 112A towards the locking end 112B of the second connector 112.

It should be appreciated that while the connectors 110 and 112 are in the locking configuration, the detent 114 is in a non-depressed state inside the second interior portion 108 of the second tubular section 104. The detent 114 may be substantially inaccessible while the connectors 110 and 112 are in the locking configuration, effectively retaining the connectors 110 and 112 in the locking configuration.

When the connectors 110 and 112 are in the locking configuration, the set screw 118 is aligned with the aperture 120, a user may be able to access the set screw 118 to fasten the set screw 118. In some embodiments, it may be desirable to fasten the set screw 118 to secure the second connector 112 to the first connector 110. In some embodiments, it may be desirable to fasten the set screw 118 to secure the second connector 112 to the second tubular section 104. In some embodiments, the first connector may include a set screw or other fastener, and the first tubular section may include an aperture that aligns with the set screw of the first connector and allows a user to fasten the first connector to the first tubular section.

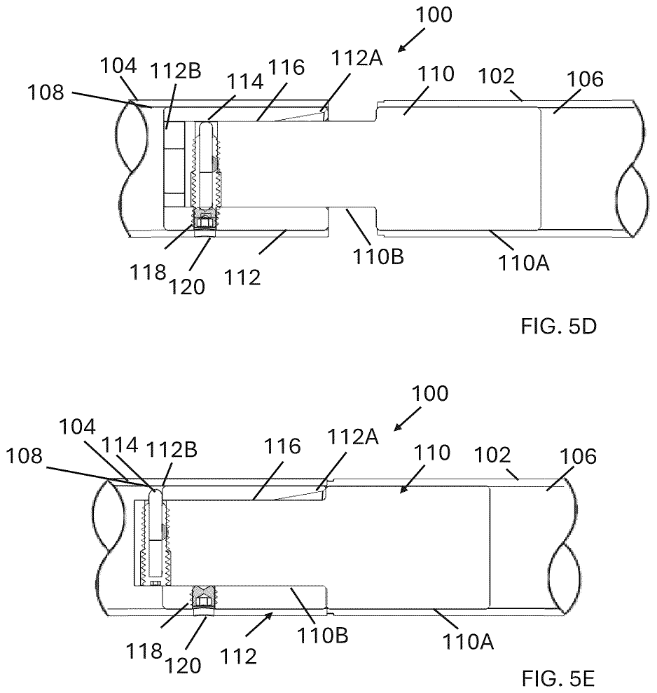

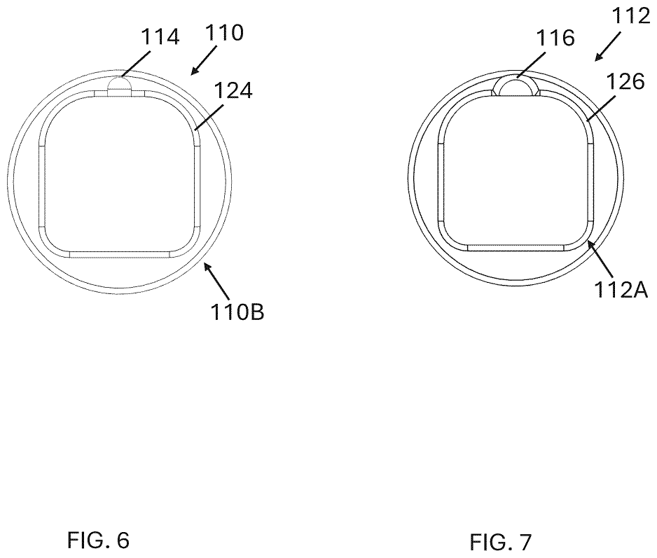

The first connector 110 and the second connector 112 may couple in a limited number of orientations, ensuring the push bar 100 is assembled properly. As illustrated in FIG. 6, the connecting end 110B of the first connector 110 may have a male configuration and have a first profile 124. The detent 114 may extend from the first profile 124. The first profile 124 may be partially rounded, so that the first profile 124 may be non-circular to configure to the second profile 126 in one rotational orientation. The profiles may be rotationally asymmetrical. It should be appreciated that in some embodiments, the first profile 124 may have a plurality of unique orientations. FIG. 7 illustrates the receiving end 112A of the second connector 112 may have a female configuration and a second profile 126. The ramp 116 may extend from the second profile 126. The second profile 126 may be partially rounded, so that the second profile 126 may be rotationally asymmetrical.

The first profile 124 and the second profile 126 may be complimentary, such that one profile may fit inside the other profile, allowing the connecting end 110B of the first connector 110 to insert inside of the second connector 112. The ramp 116 may further receive the detent 114. It should be appreciated that the first connector 110 and the second connector 112 may only couple in a single orientation. In some embodiments, the first connector 110 and the second connector 112 may be at least partially rotationally symmetrical, allowing the first connector 110 and second connector 112 to couple in a plurality of orientations. In some embodiments, the first connector 110 may have a female configuration and the second connector 112 may have a male configuration. It should be appreciated that the first profile 124 may then be larger than the second profile 126.

With the above-described devices, a modular architectural hardware device may be assembled with a connection. The connection may have two connectors that couple to interior portions of modular components of a modular architectural hardware device. The connectors may connect the modular components to form a single piece of architectural hardware.

It should be understood that the foregoing description of the invention is intended merely to be illustrative thereof and that other embodiments, modifications, and equivalents of the invention are within the scope of the invention recited in the claims appended hereto. Further, the door lock system described above includes various features that may be employed singularly or in any suitable combination.

1. A modular architectural hardware device comprising:
a first section;
a second section;
wherein the first section is configured to contact the second section when the first section is coupled to the second section, and moved to a locking configuration;
wherein the first section and the second section have complementary non-circular profiles whereby the second section is configured to be inserted into the first section in only one rotational orientation.

2. The modular architectural hardware device of claim 1, wherein the first section is a first tubular section having an interior portion, and a first connector configured to couple to the interior portion of the first tubular section wherein the first connector is configured to move to a first secure position when coupled to the interior portion of the first tubular portion;
and the second section is second tubular section having a second interior portion, and a second connector configured to couple to the interior portion of the second tubular section, the second connector further configured to couple to the first connector, wherein the second connector is configured to move to a second secure position when coupled to the interior portion of the second tubular portion; and
wherein the first section is configured to contact the second section when the first connector is coupled to the second connector, and moved to the locking configuration;
wherein the first connector and the second connector have the complementary non-circular profiles.

3. The modular architectural hardware device of claim 1, wherein the complementary non-circular profiles are partially rounded.

4. The modular architectural hardware device of claim 3, wherein the complementary non-circular profiles are approximately D shaped.

5. The modular architectural hardware device of claim 1, wherein the non-circular profiles are rotationally asymmetrical about at least one axis, the at least one axis being perpendicular to the at least one of the non-circular profiles.

6. The modular architectural hardware device of claim 1, wherein the non-circular profile of the second section further comprises a notch.

7. The modular architectural hardware device of claim 6, wherein the notch is a ramp configured to receive a locking mechanism.

8. The modular architectural hardware device of claim 7, wherein the locking mechanism is a detent of the first section, the detent configured to depress in the notch and release when the first section is in a locking position relative to the second section.

9. A modular architectural hardware device comprising:
a first section having an interior portion;
a second section having an interior portion;
a first connector configured to couple to the interior portion of the first section;
a second connector configured to couple to the interior portion of the second section, the second connector further configured to couple to the first connector;
wherein the first connector is configured to move to a first secure position when coupled to the interior portion of the first section by a press fit;
wherein the second connector is configured to move to a second secure position when coupled to the interior portion of the second section by a press fit; and
wherein the first section is configured to contact the second section when the first connector in the first secure position is coupled to the second connector in a second secure position and moved to a locking configuration.

10. The modular architectural hardware device of claim 9, wherein the second section comprises an aperture and the second connector comprises a fastener configured to align with the aperture.

11. The modular architectural hardware device of claim 10, wherein the fastener is a set screw, the set screw configured to restrict movement of the second section relative to the second connector.

12. The modular architectural hardware device of claim 9, wherein the first section comprises an aperture and the first connector comprises a fastener configured to align with the aperture.

13. The modular architectural hardware device of claim 12, wherein the fastener is a set screw, the set screw configured to restrict movement of the first section relative to the second connector.

14. The modular architectural hardware device of claim 9, wherein the first connector further comprises a ramp configured to receive a locking mechanism.

15. The modular architectural hardware device of claim 14, wherein the locking mechanism is a detent of the first connector, the detent configured to depress in the ramp and release when the first connector is in a locking position relative to the second connector.

16. A modular architectural hardware device comprising:
a first section having an interior portion;
a second section having an interior portion;
a first connector configured to couple to the interior portion of the first section;
a second connector configured to couple to the interior portion of the second section, the second connector further configured to couple to the first connector;
wherein the first connector is configured to move to a first secure position when coupled to the interior portion of the first section;
wherein the second connector is configured to move to a second secure position when coupled to the interior portion of the second section;
wherein the first section is configured to contact the second section when the first connector in the first secure position is coupled to the second connector in a second secure position, and when the first connector moves to a locking configuration;
wherein the first connector comprises a detent;
wherein the second connector comprises a ramp configured to receive the detent, the ramp having a receiving end;
wherein the ramp is sloped to receive the detent at the receiving end and depress the detent as the first connector moves towards a locking end to the locking configuration while coupled to the second connector; and
wherein the depressed detent is released when the first connector is in the locking configuration.

17. The modular architectural hardware device of claim 16, wherein the ramp is linear, allowing the first connector to move linearly relative to the second connector when coupled.

18. The modular architectural hardware device of claim 16, wherein the first connector has a male configuration and further comprises a coupling end configured to couple with the interior portion of the first section, and a connecting end configured to couple with the second connector.

19. The modular architectural hardware device of claim 18, wherein the connecting end of the first connector is configured to couple to an interior portion of the second connector, the second connector having a female configuration.

20. The modular architectural hardware device of claim 16, wherein the second connector has a male configuration and further comprises a coupling end configured to couple with the interior portion of the second section, and a connecting end configured to couple with the first connector.

21. The modular architectural hardware device of claim 20, wherein the connecting end of the second connector is configured to couple to an interior portion of the first connector, the first connector having a female configuration.
